(19) United States
(12) Patent Application Publication
(10) Pub. No.: US 2017/0137198 A1
(43) Pub. Date: May 18, 2017

(54) VARIABLE SLEEVE CLAMP

(71) Applicant: Marc Morin, Long Beach, CA (US)

(72) Inventor: Marc Morin, Long Beach, CA (US)

(21) Appl. No.: 15/354,895

(22) Filed: Nov. 17, 2016

Related U.S. Application Data
(60) Provisional application No. 62/256,261, filed on Nov. 17, 2015.

(51) Int. Cl. B65D 79/00; F16B 2/06

(52) U.S. Cl. CPC B65D 79/00; F16B 2/06

(57) ABSTRACT

A variable sleeve clamp with right and left knurled drivers that can be rotated to change the diameter of a cylindrical sleeve held therein. The variable sleeve clamp can be adjusted to bundle strands of various materials, such as appliance cords, wires, and the like. The knurled drivers can be rotated in either direction to hold and release the bundled strands.

### CROSS REFERENCE TO RELATED APPLICATION

This application claims priority to U.S Provisional Patent Application No. 62/256,261, filed Nov. 17, 2015, entitled, “VARIABLE SLEEVE CLAMP,” which is hereby incorporated by reference in its entirety.

### BACKGROUND OF THE INVENTION

The present invention generally relates to a variable sleeve clamp, more particularly to a cylindrical clamp that allows for bundling of strand materials within an adjustable sleeve.

Appliance cords, electric cables, wires, twine, writing instruments, for example, are often needed to be bundled and held together in an organized manner. Cable ties, tie wraps, zip ties, and other similar fasteners are often used to hold such items together. However, many of these fasters are one-time use fasteners, which require replacement after one use. For example, zip ties ratchet to a particular diameter to hold cables, wires, and the like together, but need to be cut to be released. As such, these fasteners are not reusable.

### SUMMARY OF THE INVENTION

The present invention provides a constant radius counter-rotating housing assembly that reduces and holds an interior sleeve to variable diameters. As such, the device can bundle a variety of stand-like materials, such as appliance cords, twine, writing instruments, for example, within an integrated adjustable and locking sleeve. The assembly in accordance with the present invention allow for adjustment of the diameter to both tighten and loosen, allowing for the device to be reused.

### BRIEF DESCRIPTION OF THE DRAWINGS

A more complete understanding of the present invention may be obtained with reference to the Detailed Description when taken in conjunction with the accompanying Drawings.

FIG. 1 is an exploded view of a clamp in accordance with one exemplary embodiment; and

FIG. 2 is a view of an assembled clamp shown in FIG. 1.

### DETAILED DESCRIPTION OF THE INVENTION

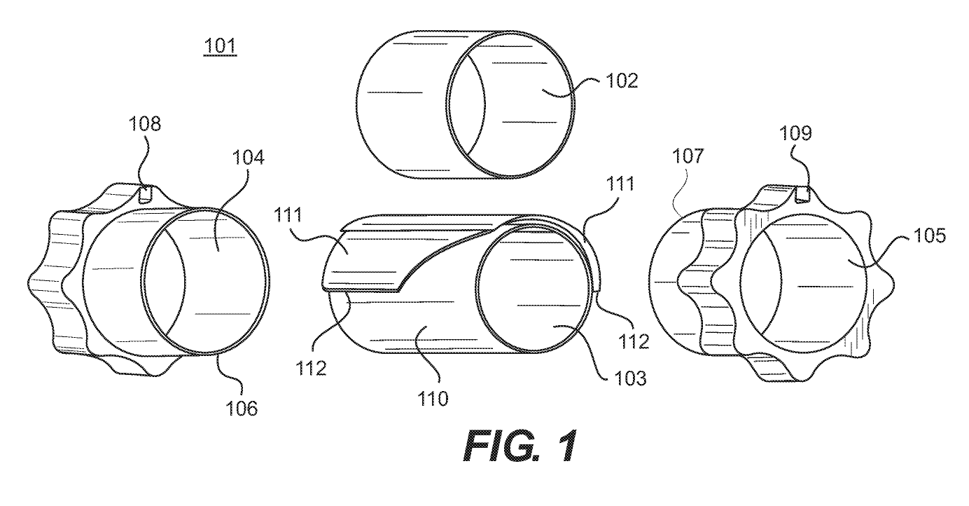

Referring now to FIG. 1, clamp 101 in accordance with one exemplary embodiment is shown in a disassembled state or exploded view. Clamp 101 generally comprises four main components: a housing or collar 102, a sleeve 103, left knurled driver 104, and right knurled driver 105. Housing or collar 101 generally holds sleeve 103, right knurled driver 104 and left knurled driver 105.

Left and right knurled drivers 104 and 105 are identical cylinders that abut at their distal ends 106 and 107, respectively. The cylindrical lengths of left and right knurled drivers 104 and 105 are approximately half that of the housing or collar 102 and sleeve 103. Knurled drivers 104 and 105 can be rotated and/or counter-rotated within the housing or collar 102 to increase or decrease the diameter of the main cylindrical portion 110 to hold the strands in place.

Left and right knurled drivers 104 and 105 can have slots 108 and 109, respectively, to allow for appliance cords to clip to the device. These slot 108 and 109 can also be in the form of hooks.

Sleeve 103 comprises an extruded or stamped sheet that fits within left and right knurled drivers 104 and 105. Sleeve 103 is of cylindrical shape, where the sleeve 103 can be formed by rolling an extruded or stamped sheet of material by overlapping its edges. Sleeve 103 generally comprises a main cylindrical portion 110 and two overlapping sections 111. The overlapping sections 111 cover approximately half of the main cylindrical portion 110 as show in in FIG. 1. Overlapping sections 111 terminate at distal ends 112, which can be separately fixed to an interior of housing or collar 102. The distal ends 112 of the sleeve are fixed by various means such as with use of an adhesive or interlocking channel, for example. In an alternate embodiment, right and left knurled drivers 104 and 105 are adhered to sleeve 103.

Knurled surfaces can be provided along one or both ends of collar or housing 102 to improve the operating grip and prevent the clamp 101 from rolling when not in use. The diameters of collar or housing 102, sleeve 103 and knurled drivers 104 and 105 can be varied to accommodate varying strand sizes and numbers. Clamps 101 can be made from a variety of materials such as plastics (preferred), metals or any other suitable material.

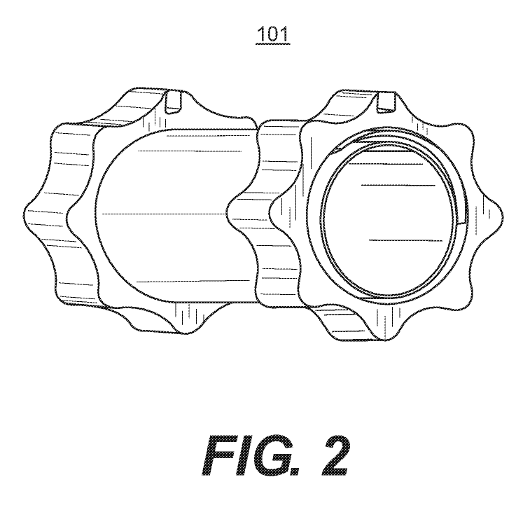

FIG. 2 shows the assembled state of the variable sleeve clamp shown in FIG. 1.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed.

1. A variable sleeve clamp comprising:
a cylindrical collar;
a cylindrical sleeve held within said cylindrical collar having a first diameter; and
left and right knurled drivers also held within said cylindrical collar and holding said cylindrical sleeve;
said cylindrical sleeve having overlapping sections that allow a diameter of the cylindrical sleeve to be varied;
wherein when one of said left or right knurled driver is rotated, said cylindrical sleeve folds on itself, reducing the first diameter to a second smaller diameter.

2. The variable sleeve clamp of claim 1, wherein said left and right knurled drivers each have finger ridges to allow a user to grasp ends of said left and right knurled drivers.

3. The variable sleeve clamp of claim 1, wherein one of said left or right knurled drivers is adhered to said cylindrical sleeve.

4. The variable sleeve clamp of claim 1, wherein said cylindrical collar is adhered to said cylindrical sleeve.
